(19) United States
(12) Patent Application Publication
(10) Pub. No.: US 2003/0169839 A1
(43) Pub. Date: Sep. 11, 2003

(54) Prefabricated in-core instrumentation chase

(76) Inventor: Donn Moore Matteson, South Windsor, CT (US)

Correspondence Address: Joseph C. Spadacene, Westinghouse Electric Company LLC, 4350 Northern Pike, Monroeville, PA, 15146, US

(21) Appl. No.: 10/095,562

(22) Filed: Mar. 11, 2002

(51) Int. Cl. G21C 19/00

(52) U.S. Cl. 376/260

(57) ABSTRACT

A prefabricated in-core nuclear plant instrumentation chase concrete form is provided that has integral embedment plates at the locations where the in-core instrumentation guide thimble supports contact the walls of the chase. Structural steel shapes are located on the outside of the prefabricated chase at the embedment locations to transfer loads on axially-spaced, transverse, thimble support plates that route and support guide thimbles through which the in-core instrumentation pass, into the surrounding concrete structure. The guide thimble supports are installed in the pre-fabricated chase form at the factory and serve to strengthen the structure during shipping and handling as well as resist the loads applied by the wet concrete poured around the prefabricated chase during installation at a nuclear plant site.

### RELATED APPLICATIONS

This application is related to U.S. patent application Ser. No. ______ (Westinghouse Docket No. N2000-007) entitled a “Nuclear Plant Containment with Prefabricated Component Support Structure”, filed concurrently herewith.

### BACKGROUND OF THE INVENTION

1. Field of the Invention

The present invention relates to the construction of nuclear steam supply systems, and more particularly, to the prefabrication of component parts for nuclear plant containment systems.

2. Description of Related Art

The invention described herein is intended to be employed as part of a nuclear steam supply system. Nuclear steam generating systems are typically enclosed within a containment structural system, which must be capable of resisting internal pressure and temperature increases caused by a Design Basis Accident (affects of an assumed loss of coolant accident) in combination with other loading requirements. The system must also be capable of providing radiation shielding during the entire life of the nuclear steam generating system, including a Design Basis Accident. These requirements have been met heretofore in several ways. One method is the application of a hermetically sealed steel containment vessel supported by a reinforced concrete foundation mat, which serves to provide leaktightness and resist internal pressure. A concrete structure, separated from the steel vessel, usually surrounds the steel vessel in order to provide radiation shielding and protection for the steel vessel against the effects of tornadoes and other external loads. This outer concrete structure is usually supported on the same foundation mat as the steel vessel. During a Design Basis Accident, the steel vessel expands as it is subjected to internal pressure and temperature increases. Because of the space between the steel vessel and the outer concrete structure, the outer concrete structure is not significantly affected by a Design Basis Accident. However, both structures must be capable of withstanding seismic loads, which may be assumed to be coincident with a Design Basis Accidents.

Another method for constructing such a containment employs a concrete structure which provides the primary structural resistance to all imposed loads. The interior of the concrete structure is lined with a membrane, usually metallic, in order to provide resistance to leakage. During a Design Basis Accident, any pressure load is passed to the concrete structure, which is usually reinforced with steel bars, or pre-stressed by means of tendons, or a combination of both. As the liner is heated during a Design Basis Accident, it is constrained by the structural concrete, which carries the pressure load. For reasons of economics, the liners have been selected as thin as practical consistent with the requirements of construction. In most applications, the liners range from approximately ¼ inch to ½ inch in thickness (0.635 to 1.27 cm).

In addition, a composite containment, which is a combination of the two foregoing construction concepts has been proposed and is described in U.S. Pat. No. 4,175,005.

In addition to the concrete employed in constructing the containment, a considerable amount of concrete is poured in forms on the metal liner floor to form the reactor well, radiation shielding around the reactor well, and the various pedestals that support the respective components of the nuclear steam supply system at prescribed elevations required for their proper operation. For example, the seal table for the in-core instrumentation drive system is typically in the order of 30 feet (7.62 m) above the reactor well floor. In-core instrumentation may include, for example, flux detectors that are inserted in guide thimbles which extend from the seal table to the underside of the reactor pressure vessel and into instrumentation tubes within the fuel assemblies in the core. The in-core flux detectors are then drawn out of the core at a predetermined rate to produce a flux map along each instrumentation tube.

A flux detector distribution system supplies the flux detectors to the thimbles attached to the instrumentation tubes within the core of the nuclear reactor. A pressurized water nuclear reactor typically has approximately 60 thimbles, but may have only 4 detectors. The flux detectors are mounted on the ends of cables, which can be wound onto reels in drive units driven by motors positioned above the seal table. A network of tubing and multiple path selectors enable any of the detectors from these reels to enter into any of the thimbles. Thimbles are routed from the seal table through support plates in a tubular chase to the underside of the reactor vessel. In-core instrumentation chases are typically J-shaped tubular hollow conduits having a plurality of axial-spaced support plates. A number of the support plates include a plurality of holes through which the respective thimbles pass. The walls of the chase are typically formed from concrete and include embedments at the support plate locations for attaching the support plates and transferring the load imparted by the guide thimbles to the surrounding concrete. An in-core instrumentation chase for bottom mounted instrumentation has a complex shape that is difficult and time consuming to erect the required concrete forms for during construction prior to pouring the concrete. Construction of nuclear plants can take in excess of 6 years due, in large part, to the construction of the concrete.

Accordingly, an improved method of construction is desired that will reduce the construction time and simplify the process, as well as reduce cost.

### SUMMARY OF THE INVENTION

The foregoing objectives are achieved by this invention by employing a prefabricated in-core instrumentation chase form that preferably has integral attachment points at the locations at which the in-core instrumentation guide thimble supports contact the walls of the chase. In the preferred embodiment, the chase is formed of steel and has steel projections extending outward at an angle to the outside surface of the chase, desirably at the support plate locations, to transfer loads into the surrounding concrete structure once the chase is installed at the plant site location and the concrete is poured. Preferably, the guide thimble supports are installed in the prefabricated chase at the factory and serve to strengthen the chase during shipping and handling as well as resist the loads of the wet concrete poured around the prefabricated chase during installation. The chase form can be reinforced locally on the exterior surface by using thicker sections, e.g., steel strips or angles, perpendicular to the axial dimension of the chase and on the interior at the support locations to replace the current support attachment members.

The steel chase is left in place after the concrete cures and makes it easier to apply the finished treatment, i.e., paint, and supplies a surface that is easier to decontaminate. Preferably, the prefabricated form is constructed in sections for ease of transport and can be assembled at the plant site where it is to be ultimately seated.

### BRIEF DESCRIPTION OF THE DRAWINGS

A further understanding of the invention can be gained from the following description of the preferred embodiments when read in conjunction with the accompanying drawings in which:

FIG. 1 is a schematic diagram of a cross-section of a nuclear plant containment and base mat;

FIG. 2 is a schematic diagram of a nuclear reactor including an illustration of an in-core instrumentation chase of a prior art design with a portion cut away to show the thimble guide tubes;

FIG. 3 is a schematic illustration of the in-core instrumentation chase of this invention showing the guide tube support plates, reinforcing ribs, and bracing for the chase; and,

FIG. 4 is a schematic illustration of an in-core instrumentation chase of this invention illustrating the guide thimbles extending through the support plates.

### DESCRIPTION OF THE PREFERRED EMBODIMENT

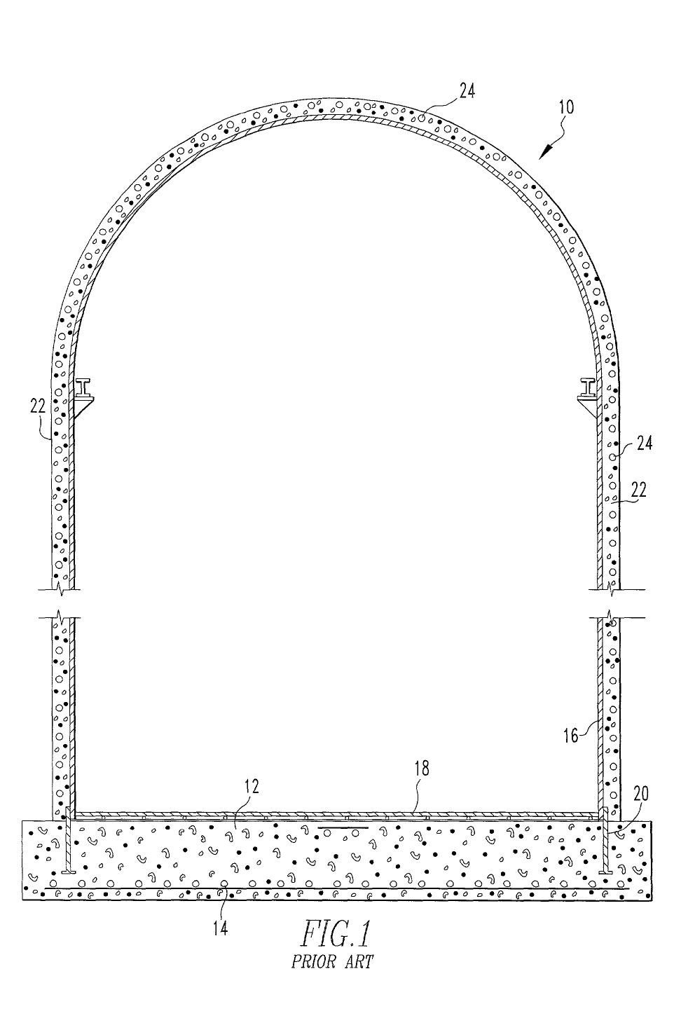

FIG. 1 illustrates a nuclear plant containment in which the prefabricated in-core instrumentation chase of this invention can be applied. The containment 10 is seated on a concrete base mat 12 having reinforcing bars 14. A hermetically sealed vessel 16 constructed from a steel vessel liner is seated on the base mat 12 and tied into the base mat through the anchors 20. A concrete shell 22 is constructed around and over the steel liner 16. The concrete shell 22 is of sufficient thickness to provide for radiation shielding and resist design loads not born by the steel vessel liner 16. The vessel 16 provides the major resistance to potential leaks. Hoop reinforcing bars or hoop pre-stressing tendons 24, or both, are provided in the concrete shell 22 to complement the steel vessel 16 in withstanding forces originating within the containment structure 10. Typically, there is an access door provided in the side of the containment 10 that is not shown.

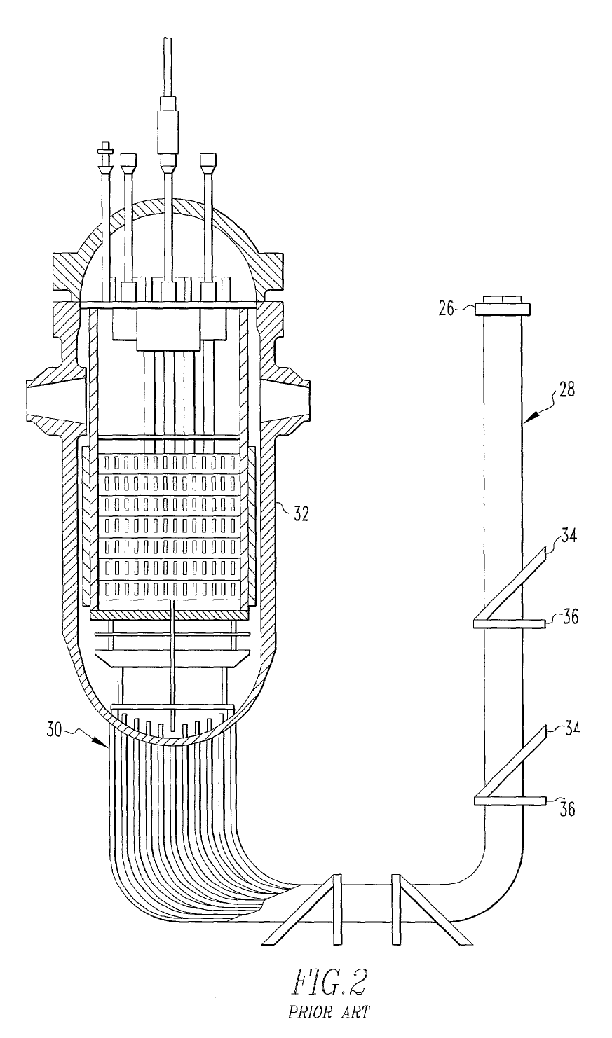

Though not evident from the schematic representation shown in FIG. 1, a good deal of the containment structure requires the pouring of concrete into complex forms to create compound shapes. Generally, a concrete floor is formed over the floor 18 of the liner 16. The concrete floor has different elevations for supporting the various components of the nuclear steam supply system. For example, a reactor vessel is supported within a concrete well that shields most of the vessel. A pressurizer, steam generators and main coolant pumps are supported at much higher levels, above the elevation of the reactor core. Similarly, as shown in FIG. 2, the seal table 26 for the in-core instrumentation is supported at an elevation above the reactor core. The chase 28, through which the in-core instrumentation guide thimbles 30 pass, between the underside of the reactor vessel 32 and the seal table 26, is embedded in a concrete structure which forms a support for the primary system components and a wall of the well surrounding the reactor vessel. Embedments 34 at the locations adjacent the support plates 36, through which the guide thimbles 30 are threaded, transfer the load on the support plates to the surrounding concrete. Typically, the chase 28 is defined by forms, which are constructed at the site prior to the concrete being poured around the forms. Because of the complex shape, the construction of the chase is time consuming and expensive.

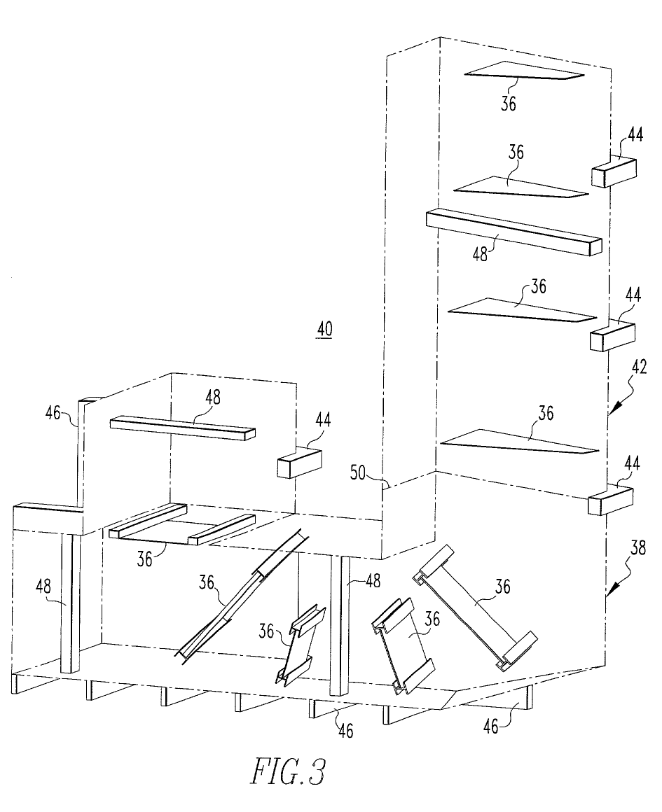

This invention reduces the time required to construct the concrete containment floor structure by providing a prefabricated chase concrete form that is set in place prior to pouring the concrete and left in place during plant life. The form is preferably made of steel and is illustrated in FIG. 3. The chase 40 is desirably constructed in a plurality of sections for ease of transport and handling. FIG. 3 shows separate lower chase section 38 and upper vertical chase section 42, which can be joined at the plant site at seam 50 either by bolting or welding. The chase concrete form can be affixed in place by attachment to the liner vessel floor 18, for example, by welding or bolting. The form 40 can be reinforced locally on the backside by using thicker sections such as the reinforcing ribs 46. Bars or other steel shapes, affixed perpendicular to the surface on the interior of the form, provide mounting locations for the in-core instrumentation supports 36, thereby replacing the embedments 34 currently used. This reduces the fitup problems and delays caused by the current support to embedment interface. The in-core instrumentation supports 36 can be pre-mounted in the form prior to installation. Preferably, this is done at the factory before shipment. The supports will act to stiffen the form 40 until the concrete cures and further reduce the site installation time. Temporary bracing 48 can also be applied for this purpose to provide added stiffness. In addition, an arrangement of plates or steel bars 44 extend at an angle, preferably perpendicular to the outside surface of the chase and are affixed to the chase to transfer loads to the surrounding concrete. Preferably, though not shown in FIG. 3, the embedments 44 are located at the support plate 36 locations. The finish treatment, e.g., paint, is easier to apply to the steel than concrete and provides a surface that is easier to decontaminate. The prefabricated form thus has a number of advantages over existing techniques and reduces the cost and time of construction.

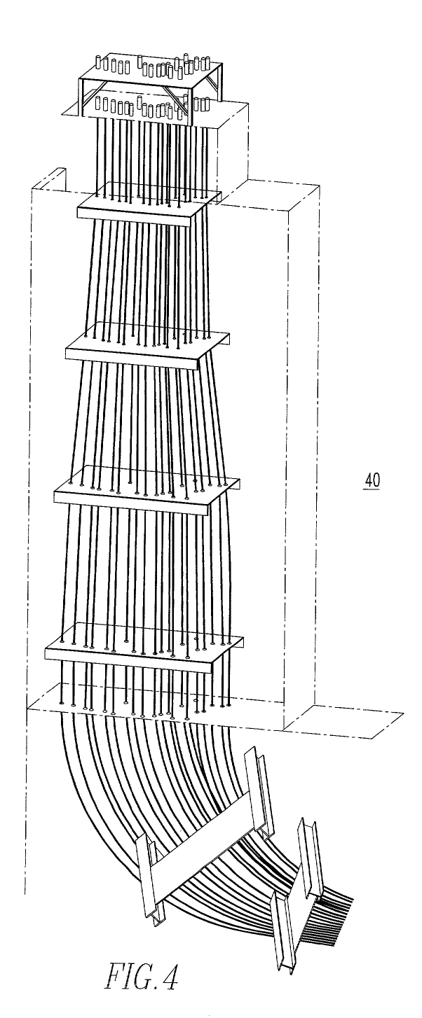

FIG. 4 illustrates a schematic of the vertical section of the chase 40 having the guide thimbles threaded through the support plates 36 as they would appear in the final installation. From the view shown in FIG. 4, one can better appreciate the complex shape of the chase 40 and why the concrete form employed to create this shape is better suited to factory fabrication.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A prefabricated nuclear reactor in-core instrumentation chase for supporting and routing a plurality of in-core instrumentation guide thimbles that extend from a seal table at an upper elevation outside a nuclear reactor vessel to an underside of the nuclear reactor vessel where the guide thimbles are coupled through the vessel to a plurality of instrumentation guide tubes within a core within the nuclear reactor vessel comprising:
an elongated generally “J” shaped tubular member, having a longitudinal axis, that is constructed at a factory at a spaced location from a nuclear plant site at which it is intended to be installed; and
a plurality of support plates respectively affixed at the factory at axially spaced locations within the interior of the tubular member, at least a portion of said plurality of said support plates substantially spanning a cross-section of the interior of the tubular member and respectively having a plurality of orifices through which the guide thimbles can be threaded and supported.

2. The prefabricated nuclear reactor in-core instrumentation chase of claim 1 wherein the tubular member is constructed in separable sections that can be assembled together at the nuclear plant site.

3. The prefabricated nuclear reactor in-core instrumentation chase of claim 1 wherein the tubular member is constructed out of metal.

4. The prefabricated nuclear reactor in-core instrumentation chase of claim 1 including a support plate attachment member affixed to an interior surface of the tubular member and extending substantially perpendicular to the interior surface of the tubular member adjacent a support plate axial location for stiffening the tubular member and affixing the support plate.

5. The prefabricated nuclear reactor in-core instrumentation chase of claim 1 wherein the tubular member includes a first axial section that is thicker than adjacent axial sections to stiffen the tubular member.

6. The prefabricated nuclear reactor in-core instrumentation chase of claim 5 wherein the thicker section extends at least partially, circumferentially along an outer surface of the tubular member at the first axial section.

7. The prefabricated nuclear reactor in-core instrumentation chase of claim 6 wherein the thicker first axial section includes a metal strip affixed to the outer surface of the tubular member at at least two circumferential locations.

8. The prefabricated nuclear reactor in-core instrumentation chase of claim 1 including an exterior embedment member attached to an exterior surface of the tubular member and extending outwardly from the exterior surface.

9. The prefabricated nuclear reactor in-core instrumentation chase of claim 8 wherein the embedment member extends outwardly from and substantially perpendicular to the exterior surface.

10. The prefabricated nuclear reactor in-core instrumentation chase of claim 8 wherein at least some of the embedment members are located at substantially the same axial locations as the support plates.

11. A method of constructing a nuclear steam supply system having in-core nuclear instrumentation that is inserted into a core of a reactor vessel from an underside of the vessel including the steps of:
manufacturing at a factory location a tubular member in the shape of a chase designed to route a plurality of guide thimbles from underneath the vessel to a seal table at an elevation above the underside of the vessel, wherein the factory location is spaced from the site at which the nuclear steam supply system is erected;
affixing a plurality of support plates within the tubular member at axially spaced locations, with at least a portion of said support plates substantially spanning a cross-section of the interior of the tubular member and respectively having a plurality of orifices through which the guide thimbles can be threaded and supported, wherein the support plates are affixed within the interior of the tubular member at the factory;
shipping the tubular member to the nuclear plant site;
placing the tubular member in position within a nuclear reactor containment at the location and orientation at which it is intended to function in the nuclear steam supply system; and
pouring concrete around at least a portion of the tubular member.

12. The method of claim 11 including the steps of:
constructing the tubular member in a plurality of axial sections:
shipping the axial sections to the nuclear plant site; and
joining the axial sections at the nuclear plant site.

13. The method of claim 12 including the step of combining the joining and placing steps.

14. The method of claim 11 including the step of attaching embedment members to an exterior surface of the tubular member.
